(19) United States
(12) Patent Application Publication
(10) Pub. No.: US 2024/0257322 A1
(43) Pub. Date: Aug. 1, 2024

(54) SPOTLIGHT IMAGE ENHANCEMENT

(71) Applicant: BAE SYSTEMS Information and Electronic Systems Integration Inc., Nashua, NH (US)

(72) Inventors: John J. Henebury, Newton, MA (US); Lori L. Vinciguerra, Reading, MA (US); Jaime A. Caicedo Baquerizo, Somerville, MA (US); Gregory W. Sletterink, Cambridge, MA (US); Robin L. Brown, Leominster, MA (US)

(73) Assignee: BAE SYSTEMS Information and Electronic Systems Integration Inc., Nashua, NH (US)

(21) Appl. No.: 18/102,872

(22) Filed: Jan. 30, 2023

(51) Int. Cl. G06T 5/00

(52) U.S. Cl. CPC G06T 5/92

(57) ABSTRACT

Systems and methods of image enhancement comprising: obtaining image data; analyzing the image data and gathering relevant statistics thereon, at least within a first region of interest and a second region of interest; using the gathered statistics corresponding to the first region of interest, configuring a first contrast enhancement module to perform contrast enhancement of at least a first portion of the image data; using the gathered statistics corresponding to the second region of interest, configuring a second contrast enhancement module to perform contrast enhancement of at least a second portion of the image data; and combining the contrast-enhanced image data to form a complete image

### FIELD OF THE DISCLOSURE

The following disclosure relates generally to image enhancement, and, more specifically, to limited, differential Contrast Enhancement (CE) of images.

### BACKGROUND

Infrared (IR) imaging, also referred to herein as thermal imaging, is commonly used in both military and commercial applications, such as surveillance cameras and night-vision systems in vehicles, to obtain visual information not otherwise detectable by the human eye. Unlike images captured by traditional cameras, however, IR images are typically low-contrast. That is, current IR sensors cannot clearly differentiate an object from its background when both have similar emissivity.

Contrast Enhancement (CE), which is the manipulation and redistributing of pixels in a linear or non-linear fashion to improve the separation of obscured structural variations in pixel intensity and create a more visually differentiable structural distribution, is widely used to improve image quality. Such techniques are especially useful when combined with IR imaging, due to these images typically being low-contrast.

CE typically begins with selecting, either automatically or by a user, a Region of Interest (ROI), with CE optimizations being tailored to maximize the visual differentiation of structural variations in the ROI. These CE optimizations are then typically applied across the entire image. Applying CE optimizations designed to enhance the ROI to an entire image, however, often results in some structural variations being made more visually differentiable with others being made less visually differentiable, especially those outside of the ROI.

For example, a thermal image of a vehicle in a hot parking lot with an individual standing next to it that is subjected to CE may result in the individual being effectively removed from the image if the ROI on which CE is based includes the vehicle, but not the individual. This is because the vehicle will show up much more strongly in such an image, leading to CE reducing the overall image intensity so that features of the vehicle can be better distinguished and, as a consequence, reducing the intensity of the portion of the image associated with the individual, thereby rendering the details thereof less differentiable than before CE.

While there are CE techniques, such as Enhance Local Contrast (CLAHE), that allow for multiple CE regions of interest, these techniques are not viable for many applications, due to their need for more significant computing resources, such as FPGA logic elements, than are commonly available on current imaging systems.

What is needed, therefore, are systems and methods of CE that require minimal resources to implement and that allow the enhancement of an ROI without reducing the separation of obscured structural variations in pixel intensity outside of the ROI.

### SUMMARY

By using two Contrast Enhancement (CE) techniques simultaneously, a first CE technique on an entire image frame and second on part of the image frame, and then blending those CE enhanced images by superimposing one image over the other, CE that requires minimal resources to implement and that allows the enhancement of an ROI without reducing the separation of obscured structural variations in pixel intensity outside of the ROI is achieved.

An exemplary embodiment of the present disclosure provides a system for image enhancement, the system comprising: an image pipeline, the image pipeline comprising: a focal plane array configured to gather image data; a first contrast enhancement module configured to receive image data from the focal plane array and to perform contrast enhancement at least of image data corresponding to a first contrast-enhanced area of an image using a first contrast enhancement technique; a second contrast enhancement module configured to receive image data from the focal plane array and to perform contrast enhancement at least of image data corresponding to a second contrast-enhanced area of an image using a second contrast enhancement technique; at least one statistics module, the statistics module being configured to receive at least image data corresponding to a first region of interest and to use this data to set appropriate configuration parameters for use by the first contrast enhancement module in performing contrast enhancement using the first contrast enhancement technique and/or to receive image data corresponding to a second region of interest and to use this data to set appropriate configuration parameters for use by the second contrast enhancement module in performing contrast enhancement using the second contrast enhancement technique; and a selection module configured to combine the output of the first contrast enhancement module and second contrast enhancement module, creating a unitary image.

Another embodiment of the present disclosure provides such a system, wherein the first contrast-enhanced area comprises the second contrast-enhanced area.

A further embodiment of the present disclosure provides such a system, wherein contrast-enhanced image data generated by the second contrast enhancement module is substituted for data generated by the first contrast enhancement module where that contrast-enhanced image data corresponds to the second contrast-enhanced area.

Yet another embodiment of the present disclosure provides such a system, wherein the first contrast-enhanced area corresponds to the entire image.

A yet further embodiment of the present disclosure provides such a system, wherein the second contrast-enhanced area corresponds to a predetermined portion of the entire image.

Still another embodiment of the present disclosure provides such a system, wherein the image pipeline is a long-wavelength infrared image pipeline.

A still further embodiment of the present disclosure provides such a system, wherein the first contrast enhancement module is configured to perform plateau equalization type contrast enhancement and the second contrast enhancement module is configured to perform linear equalization type contrast enhancement.

Even another embodiment of the present disclosure provides such a system, wherein at least one of the first region of interest or second region of interest is configured to be set by a user.

An even further embodiment of the present disclosure provides such a system, wherein at least one of the first region of interest or second region of interest is automatically selected.

A still even another embodiment of the present disclosure provides such a system, wherein the statistics module is configured to read statistics and to write contrast enhancement configuration parameters to the first contrast enhancement module and/or second contrast enhancement module during an inter-frame gap time.

Even another embodiment of the present disclosure provides such a system, wherein the first contrast enhancement module and second contrast enhancement module are configured to apply different types of contrast enhancement.

An even further embodiment of the present disclosure provides such a system, wherein the first contrast enhancement module and second contrast enhancement module are configured to apply the same type of contrast enhancement using different configuration parameters.

One embodiment of the present disclosure provides a method of image enhancement, the method comprising: obtaining image data; analyzing the image data and gathering relevant statistics thereon, at least within a first region of interest and a second region of interest; using the gathered statistics corresponding to the first region of interest, configuring a first contrast enhancement module to perform contrast enhancement of at least a first portion of the image data; using the gathered statistics corresponding to the second region of interest, configuring a second contrast enhancement module to perform contrast enhancement of at least a second portion of the image data; and combining the contrast-enhanced image data to form a complete image.

Another embodiment of the present disclosure provides such a method, wherein the first contrast enhancement module and second contrast enhancement module apply different types of contrast enhancement.

A further embodiment of the present disclosure provides such a method, wherein the first contrast enhancement module and second contrast enhancement module are configured to apply the same type of contrast enhancement using different configuration settings.

Yet another embodiment of the present disclosure provides such a method, wherein the first portion of the image data comprises all of the image data and wherein the second portion of the image data comprises a portion thereof.

A yet further embodiment of the present disclosure provides such a method, wherein the first contrast enhancement module performs plateau equalization type contrast enhancement and the second contrast enhancement module performs linear equalization type contrast enhancement.

Still another embodiment of the present disclosure provides such a method, wherein at least one of the first region of interest or second region of interest is user-defined.

A still further embodiment of the present disclosure provides such a method, wherein statistics are read and contrast enhancement parameters are written during an inter-frame gap time.

One embodiment of the present disclosure provides a computer program product including one or more machine-readable mediums encoded with instructions that when executed by one or more processors cause a process to be carried out for image enhancement, the process comprising: obtaining image data; analyzing the image data and gathering relevant statistics thereon, at least within a first region of interest and a second region of interest; using the gathered statistics corresponding to the first region of interest, configuring a first contrast enhancement module to perform contrast enhancement of at least a first portion of the image data; using the gathered statistics corresponding to the second region of interest, configuring a second contrast enhancement module to perform contrast enhancement of at least a second portion of the image data; and combining the contrast-enhanced image data to form a complete image.

Implementations of the techniques discussed above may include a method or process, a system or apparatus, a kit, or a computer software stored on a computer-accessible medium. The details or one or more implementations are set forth in the accompanying drawings and the description below. Other features will be apparent from the description and drawings, and form the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is an image without Spotlight Enhancement (SE) enabled and FIG. 1B is an image with Spotlight Enhancement (SE) enabled, in accordance with embodiments of the present disclosure;

FIG. 2 is a diagram illustrating the different contrast-enhanced areas of the image and different Regions of Interest (ROIs), where CE information is obtained for each contrast-enhanced area, in accordance with embodiments of the present disclosure;

FIG. 3 is a flowchart describing the CE process, in accordance with embodiments of the present disclosure; and

FIG. 4 is a block diagram showing an image pipeline, in accordance with embodiments of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The present disclosure provides a solution to limitations currently present in Contrast Enhancement (CE) systems and techniques, as described in the preceding background section. Embodiments of the present disclosure solve these limitations by providing what is herein referred to as Spotlight Enhancement (SE). In embodiments, SE provides CE of a portion of a contrast-enhanced image. In such embodiments, an image may be partially or entirely subjected to a first CE technique while a relatively smaller portion of the image is subjected to a second CE technique, with the images then being combined into a single image, in embodiments creating a picture-in-picture style image. By applying different CE techniques and/or degrees of CE to these two portions of the image, features of interest can be made more visually differentiable without adversely impacting the remainder of the image and, in embodiments, while enhancing the remainder of the image as well.

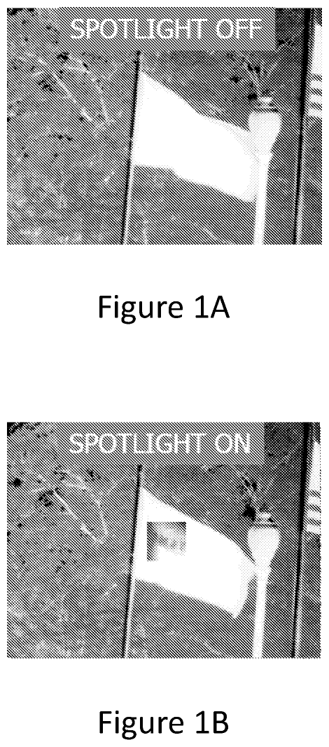

FIGS. 1A and 1B show an image without and with SE, respectively, in accordance with embodiments of the present disclosure. In FIG. 1B, the previously washed-out details of the flag, as seen in FIG. 1A, become available after SE without adversely impacting the remainder of the image.

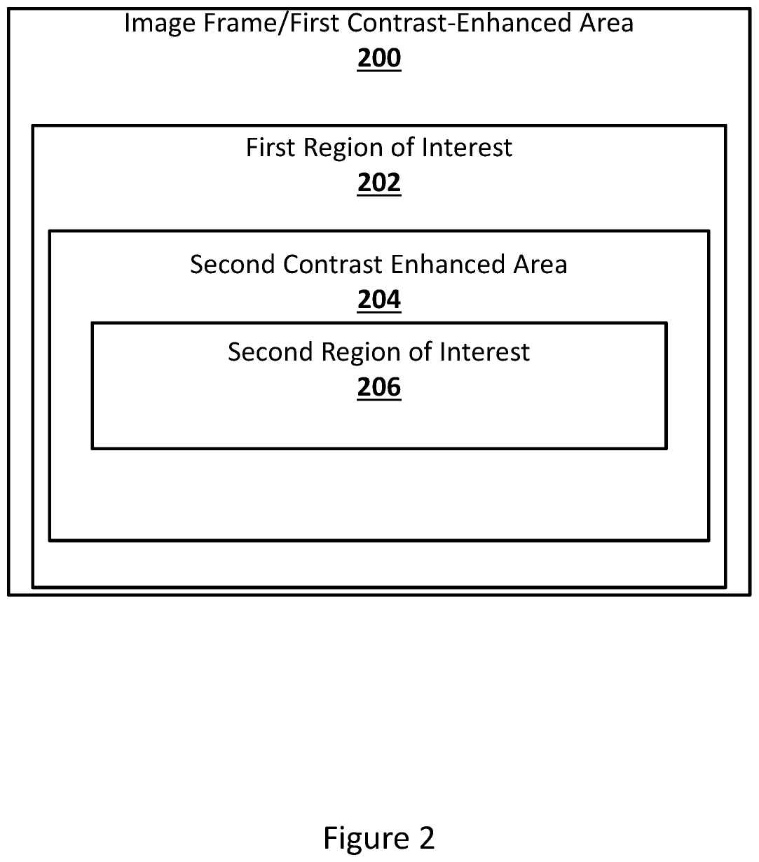

As shown in FIG. 2, embodiments of the present disclosure support at least two Regions of Interest (ROIs), with a first ROI 202 being used to determine CE optimizations that are applied to a first contrast-enhanced area 200 and a second ROI 206 being used to determine CE optimizations that are applied to a second contrast-enhanced area 204 that covers a portion of an image frame 200 and is within a portion of the first contrast-enhanced area 200. Following this initial processing, the two images are combined, with the pixels corresponding to the second contrast-enhanced area 204 being superimposed over or otherwise substituted for those of the first contrast-enhanced area 200 to produce a picture-in-picture type image, which may also be referred to herein as a unitary image. This allows each of the images that makes up the unitary image to be enhanced in a way that maximizes the visual differentiation between elements while minimizing the processing power required.

In embodiments, the first contrast-enhanced area 200 comprises the entire image frame 200. In embodiments, the first ROI 202 also comprises the entire image frame 200.

In embodiments, the second ROI 206 comprises the entire second contrast-enhanced area 204. In embodiments, the second ROI 206 comprises at least a portion of the first contrast-enhanced area 200.

In embodiments, each of the first ROI 202 and second ROI 206 may be user defined or automatically selected.

In embodiments, CE is accomplished by recording the minimum and maximum pixel intensity values in an ROI and using those values to configure tunable parameters (e.g. weighting factors, upper and lower limits, etc.), which may also be herein referred to as configuration parameters, of a linear equalization, also known as automatic gain control, type CE, in an associated contrast-enhanced area (i.e. the optimizations determined to be appropriate for the first region of interest 202 are applied to the first contrast-enhanced area 200), as would be known to one of ordinary skill in the art.

In embodiments, CE is accomplished using Plateau Equalization (PLTEQ), also known as clipped histogram equalization, type CE, as would be known to one of ordinary skill in the art.

In embodiments, PLTEQ is used to enhance the entire image frame 200 while linear equalization is used to enhance a portion of the image frame 200, although other techniques, such as CLAHE, Local Area Contrast Enhancement (LACE), and others, could be used without departing from the inventive concepts described herein.

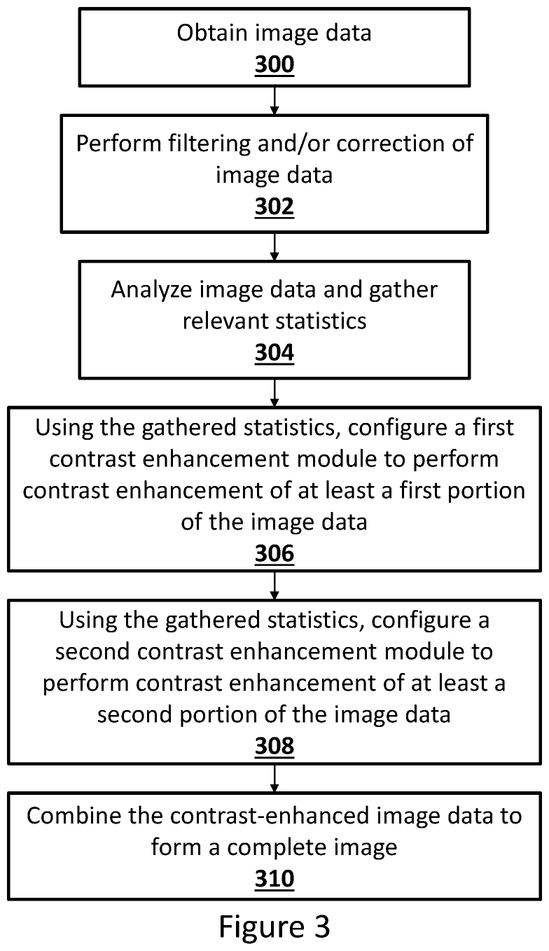

The method of Spotlight Enhancement (SE), in accordance with embodiments of the present disclosure, is more specifically laid out in FIG. 3. More specifically, embodiments of SE comprise obtaining image data 300; analyzing the image data and gathering relevant statistics 304; using the gathered statistics, configuring a first contrast enhancement module 408 to perform contrast enhancement of at least a first portion of the image data 306; using the gathered statistics, configuring a second contrast enhancement module 410 to perform contrast enhancement of at least a second portion of the image data 308; and combining the contrast-enhanced image data to form a complete image 310, which may also be herein referred to as a unitary image.

In embodiments, the first contrast enhancement module 408 and second contrast enhancement module 410 are configured to apply different types of contrast enhancement or to apply the same type of contrast enhancement using different configuration parameters. For instance, in embodiments, the first contrast enhancement module 408 and second contrast enhancement module 410 are configured to apply PLTEQ type contrast enhancement, however, because, in embodiments, tunable parameters, i.e. configuration parameters, of the first contrast enhancement module 408 and second contrast enhancement module 410 are determined using the statistics gathered from the corresponding ROI, these tunable parameters will differ, resulting in different levels of CE being performed, optimizing both contrast enhanced areas of the image.

In embodiments, filtering and/or correction of image data 302 is performed prior to analyzing the image data and gathering relevant statistics 304.

In embodiments, each of the first contrast enhancement module 408 and second contrast enhancement module 410 perform contrast enhancement of all image data.

In embodiments, the first portion of the image data comprises the second portion of the image data. In such embodiments, combining the contrast-enhanced image data to form a complete image 310 comprises superimposing or otherwise replacing pixels in the first portion of the image data with pixels from the second portion of the image data.

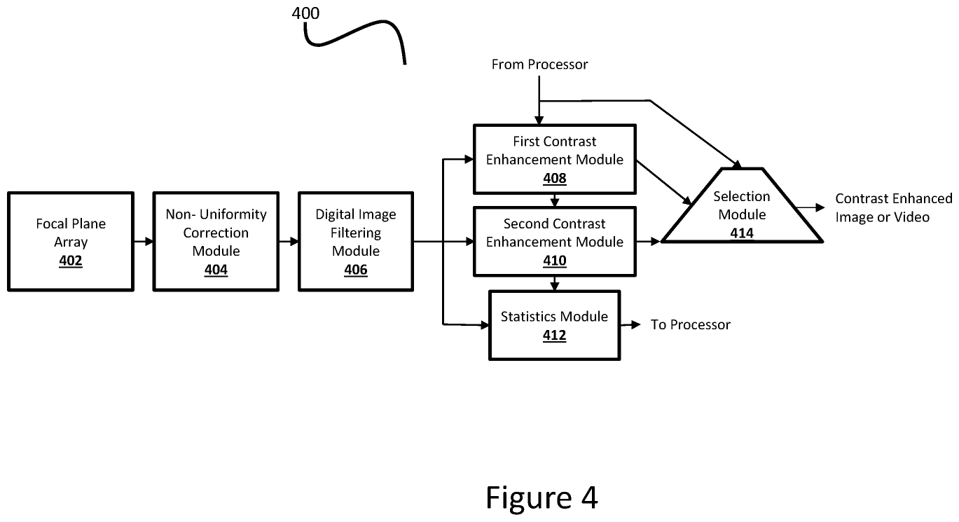

Now referring to FIG. 4, a block diagram shows how SE fits into an image pipeline 400, such as an Infrared (IR) pipeline 400. More specifically, the embodiment depicted in FIG. 4 shows a Focal Plane Array (FPA) 402 in operative communication with at least a first contrast enhancement module 408, a second contrast enhancement module 410, a statistics module 412, and a selection module 414, each of which is in operative communication with at least one processor, which may be the same processor or different processors in operative communication with one another. The at least one processor is also in further communication with non-transitory storage containing instructions that cause the various modules to perform as described herein.

In such embodiments, the statistics module 412 is configured to gather image frame 200 data necessary to configure parameters of a CE technique in use by either or both contrast enhancement modules and to provide these statistics to embedded software located on the non-transitory storage in communication with the at least one processor and/or to update these configuration parameters on either or both of the CE modules 408/410 directly. The statistics gathered may include minimum and maximum pixel intensity values in an ROI, the sum of all pixel intensity values in an ROI, or similar information needed to configure the CE modules 408/410. In embodiments, the statistics module 412 is external to the CE modules 408/410 while, in other embodiments, the statistics module 412 is internal to one or both of the CE modules 408/410. In embodiments, the statistics module 412 comprises multiple statistics modules 412, which may be internal and/or external to the CE modules 408/410.

The first contrast enhancement module 408 and second contrast enhancement module 410 are configured to receive configuration information from the at least one processor (or from the statistics module 412 directly), to configure CE parameters in accordance with the configuration information, to apply CE to data representing at least a portion of the image frame 200, and to then output that data to the selection module 414.

In embodiments, each of the first contrast enhancement module 408 and second contrast enhancement module 410 is configured to apply CE to data representing the entire image frame 200.

Now regarding the selection module 414, it is configured to combine the CE enhanced image data provided by the first and second contrast enhancement modules 408/410 into a single image or frame (if video) and to output this data, in embodiments to a display. More specifically, the selection module 414 is configured to superimpose the pixels corresponding to the second contrast-enhanced area 204 that are generated by the second contrast enhancement module 410 over, or otherwise substitute them for, those of the first contrast-enhanced area 200 that are produced by the first contrast enhancement module 408. This produces a picture-in-picture type feature with different CE applied to each of the images, preventing one CE technique from obscuring details in a different contrast-enhanced area of the image.

In embodiments, the selection module 414 is configured to provide manual and/or automatic selection of at least one ROI for enhancement. In embodiments, automatic selection is accomplished by scanning for clusters of extreme intensity value pixels, whether those extreme values are low or high, and to draw the ROI around the most extreme values. In other embodiments, pre-programmed values are used to force the ROI to initially be a certain, predetermined portion of the image frame 200. In embodiments, the predetermined portion of the image frame 200 is the center of the image frame 200.

In embodiments, the FPA 402 is an IR FPA 402.

In embodiments, especially those involving an IR FPA 402, a non-uniformity correction (NUC) module 404 may be disposed between the FPA 402 and contrast enhancement modules 408/410 and statistics module 412. The NUC module 404 of such embodiments is configured to adjust for detector drift that occurs as the scene and environment change and to correct for interference cause by heat generated by the camera. More specifically, the NUC module 404 is configured to measure the radiation from its own optics and then adjust the image frame 200 based on those readings. Even more specifically, the NUC module 404 of embodiments is configured to adjust gain and offset for each pixel, producing a higher quality, more accurate image.

In embodiments, a digital image filtering module 406 may be disposed between the FPA 402 or NUC module 404 and contrast enhancement modules 408/410 and statistics module 412. The digital image filtering module 406 of such embodiments is configured to smooth the image by suppressing high frequencies, enhance edges in the image by suppressing high frequencies, reduce noise by averaging pixel intensity values, or perform other types of filtering, as would be known to one of ordinary skill in the art.

In embodiments, the first contrast enhancement module 408 and/or second contrast enhancement module 410 are configured to perform a Plateau Equalization (PLTEQ) and/or a Gain and Level (GNLVL) type CE.

In embodiments, a line buffer is used to delay and store pixels, in embodiments by ˜5 lines, so that they can be provided to modules for processing.

In embodiments, the embedded software holds a list of statistics that can be read out by a user.

In embodiments, an FPGA, an integrated circuit designed to be configured by a customer or a designer after manufacturing, is used to perform the described processing of data. More specifically, in embodiments an FPGA may be used to calculate statistics and provide them to the embedded software via a Processor Interface Register (PIFREG), with the embedded software reading those values and updated CE parameters for a subsequent frame. In such embodiments, as a scene changes, CE parameters are updated such that CE is consistently optimized.

In embodiments, the statistics are read and CE parameters written during an inter-frame gap time, the idle time between any given two frames.

Lastly, while reference is made to “images” throughout the present disclosure, this does not exclude video from being processed using the systems and methods described herein, with images referring to frames of a video, which, in embodiments, is a real-time or substantially real-time video.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A system for image enhancement, the system comprising:
an image pipeline, the image pipeline comprising:
a focal plane array configured to gather image data;
a first contrast enhancement module configured to receive image data from the focal plane array and to perform contrast enhancement at least of image data corresponding to a first contrast-enhanced area of an image using a first contrast enhancement technique;
a second contrast enhancement module configured to receive image data from the focal plane array and to perform contrast enhancement at least of image data corresponding to a second contrast-enhanced area of an image using a second contrast enhancement technique;
at least one statistics module, the statistics module being configured to receive at least image data corresponding to a first region of interest and to use this data to set appropriate configuration parameters for use by the first contrast enhancement module in performing contrast enhancement using the first contrast enhancement technique and/or to receive image data corresponding to a second region of interest and to use this data to set appropriate configuration parameters for use by the second contrast enhancement module in performing contrast enhancement using the second contrast enhancement technique; and
a selection module configured to combine the output of the first contrast enhancement module and second contrast enhancement module, creating a unitary image.

2. The system of claim 1, wherein the first contrast-enhanced area comprises the second contrast-enhanced area.

3. The system of claim 2, wherein contrast-enhanced image data generated by the second contrast enhancement module is substituted for data generated by the first contrast enhancement module where that contrast-enhanced image data corresponds to the second contrast-enhanced area.

4. The system of claim 1, wherein the first contrast-enhanced area corresponds to the entire image.

5. The system of claim 4, wherein the second contrast-enhanced area corresponds to a predetermined portion of the entire image.

6. The system of claim 1, wherein the image pipeline is a long-wavelength infrared image pipeline.

7. The system of claim 1, wherein the first contrast enhancement module is configured to perform plateau equalization type contrast enhancement and the second contrast enhancement module is configured to perform linear equalization type contrast enhancement.

8. The system of claim 1, wherein at least one of the first region of interest or second region of interest is configured to be set by a user.

9. The system of claim 1, wherein at least one of the first region of interest or second region of interest is automatically selected.

10. The system of claim 1, wherein the statistics module is configured to read statistics and to write contrast enhancement configuration parameters to the first contrast enhancement module and/or second contrast enhancement module during an inter-frame gap time.

11. The system of claim 1, wherein the first contrast enhancement module and second contrast enhancement module are configured to apply different types of contrast enhancement.

12. The system of claim 1, wherein the first contrast enhancement module and second contrast enhancement module are configured to apply the same type of contrast enhancement using different configuration parameters.

13. A method of image enhancement, the method comprising:
obtaining image data;
analyzing the image data and gathering relevant statistics thereon, at least within a first region of interest and a second region of interest;
using the gathered statistics corresponding to the first region of interest, configuring a first contrast enhancement module to perform contrast enhancement of at least a first portion of the image data;
using the gathered statistics corresponding to the second region of interest, configuring a second contrast enhancement module to perform contrast enhancement of at least a second portion of the image data; and
combining the contrast-enhanced image data to form a complete image.

14. The method of image enhancement of claim 13, wherein the first contrast enhancement module and second contrast enhancement module apply different types of contrast enhancement.

15. The method of image enhancement of claim 13, wherein the first contrast enhancement module and second contrast enhancement module are configured to apply the same type of contrast enhancement using different configuration settings.

16. The method of image enhancement of claim 15, wherein the first portion of the image data comprises all of the image data and wherein the second portion of the image data comprises a portion thereof.

17. The method of image enhancement of claim 16, wherein the first contrast enhancement module performs plateau equalization type contrast enhancement and the second contrast enhancement module performs linear equalization type contrast enhancement.

18. The method of claim 13, wherein at least one of the first region of interest or second region of interest is user-defined.

19. The method of claim 13, wherein statistics are read and contrast enhancement parameters are written during an inter-frame gap time.

20. A computer program product including one or more machine-readable mediums encoded with instructions that when executed by one or more processors cause a process to be carried out for image enhancement, the process comprising:
obtaining image data;
analyzing the image data and gathering relevant statistics thereon, at least within a first region of interest and a second region of interest;
using the gathered statistics corresponding to the first region of interest, configuring a first contrast enhancement module to perform contrast enhancement of at least a first portion of the image data;
using the gathered statistics corresponding to the second region of interest, configuring a second contrast enhancement module to perform contrast enhancement of at least a second portion of the image data; and
combining the contrast-enhanced image data to form a complete image.
